(19) United States
(12) Patent Application Publication
(10) Pub. No.: US 2010/0057567 A1
(43) Pub. Date: Mar. 4, 2010

(54) REAL-TIME SYSTEM AND METHOD TO DISSEMINATE INFORMATION

(76) Inventor: Natesh Babu Desu Ramanjaneyulu, Bangalore (IN)

Correspondence Address: BIRCH STEWART KOLASCH & BIRCH, PO BOX 747, FALLS CHURCH, VA, 22040-0747, US

(21) Appl. No.: 12/515,993

(22) PCT Filed: May 3, 2007
(86) PCT No.: PCT/IN07/00176

§ 371 Date: Jun. 12, 2009

(30) Foreign Application Priority Data
Nov. 22, 2006 (IN) 2165/CHE/2006

(51) Int. Cl. G06Q 30/00

(52) U.S. Cl. 705/14.54; 705/1.1; 705/14.49

(57) ABSTRACT

A system and method to disseminate information. The system (2) is typically used for advertising and, in general, for the distribution of information to several end-users. It uses a request-based model in that information (35) is only sent to parties requesting the information and is therefore useful in identifying real needs. It aggregates material from clients (1, 10, 11, 12), providing a conduit for potential customers (3, 30, 31, 32) who request (33) information relating to products and services offered by the client. The client is allowed to access, modify, view, and save (13, 14, 15, 16) product and service information. The system is also capable of analyzing data pertaining to customers, which it has aggregated, and converting it into meaningful information, which will have relevance to the client. It allows for secure and quick response to an incoming customer request for information.

### FIELD OF THE INVENTION

The present invention relates to a system and method for delivering information, specifically brochures, enhancing the effect of advertisements placed in digital and print media.

### DISCUSSION OF PRIOR ART

In order to market their goods and services, businesses use a variety of advertising means. These include print and digital media, besides several others. In the case of print media, advertisements are placed on banners, handouts, newspapers, magazines etc. with details about the product or service or details on how to obtain brochures for the product or service. In the case of digital media, the means of advertising include television commercials, internet commercials, sending potential customers emails etc. In the case of digital media, the challenges for the business placing the advertisement are different than in the case of print media. Advertisements placed in print media are more persistent, in that they can be carried and used by the customer at any time, and consequently remain in the customer's memory for a longer time-period. In the case of digital media, the advertisements on television might appear only for a short duration. A consumer's memory for advertisements has been studied in several arenas and remains one of the biggest challenges for companies. Second, in the case of internet commercials, besides appearing for a short duration, the advertising campaigns need to consider the rights to privacy of the end customers. Sending SPAM e-mails has not been considered a desirous practice when trying to build brand-names. Thus, services, which automatically send millions of advertisements to every potential customer based on lists created by data-mining companies are a less attractive alternative.

WO2006/056775 discloses A Brochure System, which enables the electronic display of a brochure. This invention also allows control over the direction of browsing (forward vs. backward), the speed of browsing, enabling images and displaying text and images together. US2004164975 discloses a Method, system, apparatus, and computer program product for controlling and browsing a virtual book, which allows a user to browse a book, place the book on digital media etc. EP1222612 discloses a Method and System for delivery of a brochure wherein the users are allowed to request a brochure by means of a sensing device, whose use is monitored by a computer. This invention requires a marking nib on the sensing device. Further, this system uses a set of netpages, which are similar to regular webpages, whose components include hyperlinks, images etc. The user uses a sensing device, provided with a stylus, to indicate the features within a netpage which are of interest to him. A netpage printer is a component of this system which is used to print out the final information, and is present in places like the users kitchen etc. GB2420115 discloses a Brochure dispensing machine, which includes a selection device and a brochure printer. A user is allowed to select a brochure by means of a display and an input device and the brochure is extracted from a conveniently placed aperture.

The present invention primarily engages two entities, clients and customers. Clients are allowed to maintain a repository of their advertising brochures in the system of the present invention. Further, they are allowed to update, edit and manipulate the information associated with the brochures, while having full access to the customer list, which is maintained in the system. The customer list is created by the system by aggregating customer details. The customers are allowed to ask for brochures by sending a request to the system of the present invention, by providing their details. The system receives these requests and sends the customers the relevant brochures. This is different from the systems proposed by prior art in the entities involved, the responsive fashion in which the system is able to take advantage of a customer's short-term memory for ads placed in digital media, the seamless integration of requests and customer information and the round-the-clock availability of the system to deliver brochures to customers.

### SUMMARY OF THE INVENTION

The present invention discloses a responsive system and a method to deliver documents in general, using a request-based model. This implies that a potential end-customer, requests for information about a certain product or service, by sending a message to a pre-specified destination. The customers can place requests using different means, including means which enable the users to instantaneously contact the system. The system of the present invention receives these messages, validates them and proceeds to deliver the requisite documents to the customers. This ameliorates the problem of a customer potentially being irritated by receiving unnecessary solicitations from businesses and builds goodwill. The businesses employing the system and method of the present invention have a transparent method of aggregating their brochures and having the system respond to their customer's requests at all hours of the day, all days of the week. This extended uptime reduces the cost of setting up call-centers and other such public relations setups and provides a low-cost alternative for marketing. Further, since the users are able to react instantaneously in placing their requests with the system, full advantage can be taken of advertising media such as television or other digital media, including print media, as the user is not required to remember the details of where to place his or her requests for longer than the time taken to place the request. Added to this, businesses can now access lists of customers who have indicated an interest in their products or services, edit the material which they make available in their brochures, incorporate material existing in a variety of formats in their brochures and maintain all this at a single location in the data-store of the present invention. Further, analysis can also be performed on the customers data to collect information which is meaningful to the client.

The present invention discloses a system and method to deliver brochures relating to products and services to various customers requesting these brochures. Typically, the system of the present invention includes brochures from various clients, each of whom sell the products or services detailed in the brochures. The content of the brochures is designed by the clients themselves and can incorporate material in a variety of formats. A brochure data-store is indexed by clients and sent electronically to customers requesting such brochures. Besides being able to populate the data-store with their brochures, the clients are also provided means to edit their brochures, store images relating to their brochures and view a list of requests in order to analyze and maintain a record of potential customers, offer new services to regular customers, understand the demographics of their existing customers etc.

In the regular course of things, the customers respond to ads placed in various print and digital media for the product or service in question, send an request to a particular number, along with their e-mail address and a brochure is delivered to that address by the system after validation. The method to carry out these operations includes the steps of:
Collecting and storing data (brochures) from the clients, pertaining to their various products and services.
Indexing the data, associating keywords with specific brochures and making these keywords available to the clients for use in their ads.
Processing incoming messages from customers, requesting certain brochures.
Validating the customer's contact details.
Upon validation, if the address is found to be valid, sending an acknowledgement to the customer and then a brochure to the customer at that address
Upon validation, if the address is found to be invalid, sending an error-message to the customer.
Aggregating and analyzing customer data to provide meaningful information to the client.

In one embodiment of this invention, the customers can send their requests 33 by utilizing the Short Message Service (SMS), which is enabled in most mobile technologies world-wide. Typically, the request would be sent to a pre-specified number (4, 6 or 10-digits long), which ultimately leads to the system of the present invention. Further, the request could contain the e-mail address of the customer for rapid digital/electronic delivery of the sales brochures. Since the SMS is sent from a mobile platform, the customer's mobile phone number is immediately transmitted as part of the message. The messages could come in from mobile operators in a variety of domains (such as GSM, CDMA etc.). Further, the data about the customers can be analyzed to provide meaningful information to the clients. This would include such information as the originating location of the requests, the date-based statistics and information about the frequency of requests, the number of requests based on the keywords handed to the clients and the geographical breakdown of the requests etc. This information can further help clients analyze their customer's profiles, keep updated of the popularity of keywords etc. This technology can be utilized in a variety of domains including but not limited to, sending out brochures, application forms for various institutions, sending out prospectus information, sending out technical information and literature concerning products, sending out price-lists about components/services/products, current stock and inventory information, subscription forms, membership forms, company profiles used by marketing people in the field etc.

### BRIEF DESCRIPTION OF DRAWINGS

FIG. 1 depicts an overview of the system of the present invention.

FIG. 2 depicts an overview the method to enable a client's interaction with the present invention.

FIG. 3 depicts an overview of the method to enable a customer's interaction with the present invention.

FIG. 4 depicts the method of activating new clients in detail.

FIG. 5 depicts an overview of the customer details available to the client.

FIG. 6 depicts the customer details made available to the client in one embodiment of the present invention.

FIG. 7 depicts an overview of the method to deliver the information to the customers.

FIG. 8 depicts the population of the data-store in the system of the present invention.

FIG. 9 depicts customer data being converted into meaningful information for the client.

### DETAILED DESCRIPTION OF THE PREFERRED EMBODIMENTS

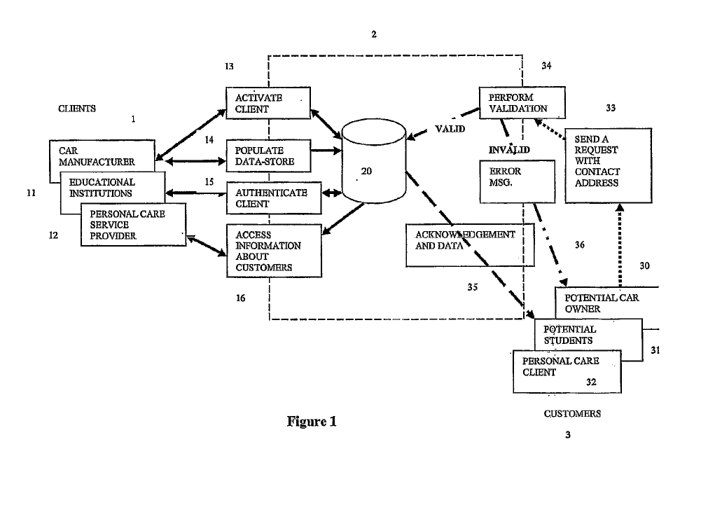

FIG. 1 shows an overview of the system of the present invention. There are three main entities interacting with each other. The clients 1, the system 2, and the customers 3. The clients could represent a variety of businesses such as car manufacturers 10, educational institutions 11 or personal care service providers 13, to cite some representative examples. This is by no means a comprehensive list of clients but only an exemplary set. Further the customers could be any consumer who wishes to buy cars 30, enroll for courses 31 or avail personal care services 32. The system 2 is comprised of a data-store 20 and a set of sub-processes or methods to handle its interactions with the customers and clients. The data store could be any of a commercial data-base, a non-commercial database or any known storage means. The data store that is used needs to be populated initially and is accessible for the purposes of retrieval, performing updates and processing interactions with other entities of the system. Typically, clients go through an activation process 13 wherein they establish their requirements with the system. Once the clients have been activated, they are assigned keywords that they may disseminate in their digital ads, allowed to populate 14 the data-store 20 with their sales material, brochures and information. The means to populate, access, update and process various interactions with entities with the data-store could be any of the conventional methods of data-entry or any other known methods. All accesses to the system have a mandatory authentication process 15 which establishes the identity of the client with the system and allows the client to access 16 customer lists pertaining to requests for their products or services. Customers 3 interact with the system by sending a request 33 along with their contact address. Upon receiving this request, the system performs validation checks 34 which establish the correctness and authenticity of the customer's message. If the customer sends a valid message, an acknowledgement along with the data is sent back to the customer 35. If the customer sends an invalid message, an error message 36 is communicated back to the customer.

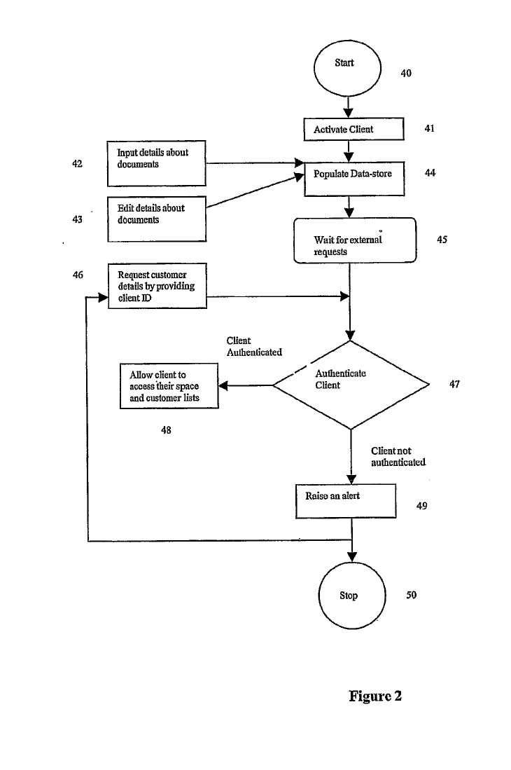

FIG. 2 depicts an overview the method to enable a client's interaction with the present invention. The client is allowed to input the details required by the system in an interactive fashion. Further, the client can enter the details via the world-wide-web, by using forms designed for this system, accepting the client's input in each field of the form. The start of the method 40 is followed by the step of client activation 41. The clients are allowed to input details about their sales information or documents 42, further having the capability to edit the same material 43 over time. This information is used to populate the data store 44. Once the data store has been populated, the system waits for external requests 45. A client can request customer details by providing an ID supplied to them 46. This would enable the clients to assess their customer demographics and send promotional material in other formats etc. The means to analyze data pertaining to customers to provide information to clients includes a variety of data-mining techniques, analytical tools and other methods custom-built for this purpose. The system first authenticates the client 47. If the client is authenticated, they are allowed to access their space or customer lists 48, typically stored in the systems data store. Accessing to the data-store is only allowed for authenticated entities or clients. The clients are allowed to manipulate their portion of the data-store and perform a variety of actions including the creation of redundant copies of the current data-store for failure resolution. The system can also perform the act of creating redundant copies of the data-stores of clients, processing alerts, which are raised in the case of suspected abuse and further, suspending the rights of the entities interacting with the system, in case such abuse is detected and verified. If the client is not authenticated, the system raises an alert 49. The clients interaction stops 50 with these set of steps. Several clients can access the system at once, or one client can access the system several times, simultaneously or sequentially.

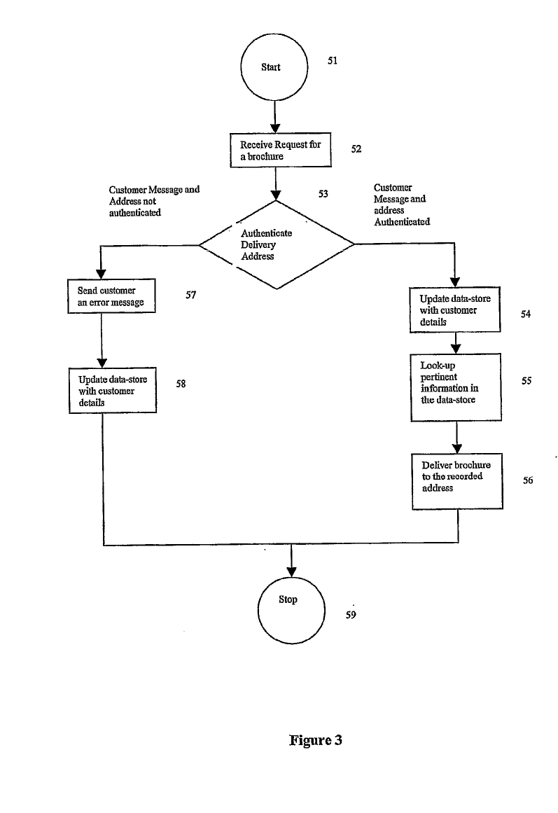

FIG. 3 depicts an overview of the method to enable a customer's interaction with the present invention. The process starts 51 by the system receiving a request for sales information, typically brochures, from the customer 52. The system authenticates the delivery address and message provided by the customer 53. If the customer message and address provided is authenticated, the system updates its data-store with the customers information 54. The process of updating the system's data-store could further include the identification of customers who have been sent material, which is accomplished by keeping track of the recipients of the material and co-relating this list with the list of customers. The data-store could also be updated to include the client's comments on the interaction with one or many customers. The system could also update the data-store in order to keep track of a client-subscription's validity. Further, the client is allowed to update the data-store to add or include information, images and supplemental material, as they see fit. After this, it looks up the requested information in its data store 55 and delivers it to the customer 56. The information that is delivered to the customer is primarily the promotional material, placed by the client, in the system's data-store. This information could be in the form of brochures, short presentations etc. If the customer's message and address are not authenticated, the system sends the customer an error message 57, which could be in the form of an SMS, an e-mail or any other mode of direct communication and further updates its data store with the customers information 58 after which the process of the customers interaction with the system stops 59. Several customers can access the system simultaneously and receive information concurrently.

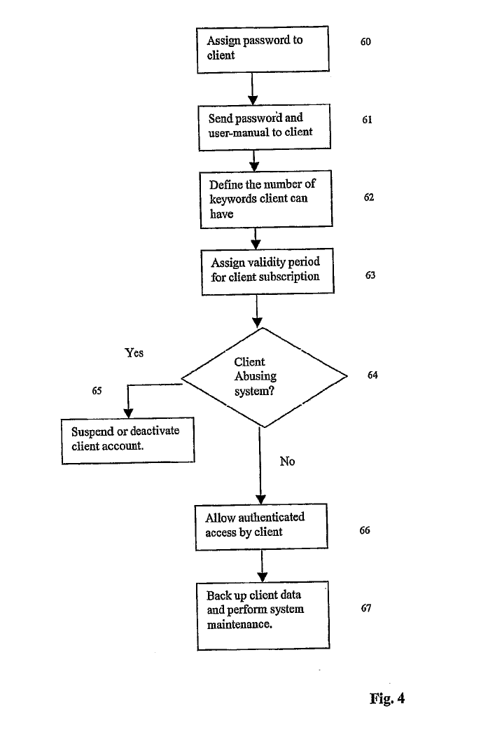

FIG. 4 depicts the method of activating new clients in detail. A set of steps has to be performed in the process of activating a new client. Typically an administrator of the system is granted the capability to perform these steps. While no particular order or periodicity is required while performing these steps, we list the steps for the sake of discussion. Initially, the system starts by assigning a password to the client 60. The password is sent to the client 61. The client could also receive other related information such as user manuals 61. The system defines the number of keywords, which a client can have within the system 62. These keywords are essentially indices to organize the sales brochures and information by. Typically they are short and descriptive of the particular product or service for which a customer can obtain sales information. Further, the keywords are typically placed in the digital advertisements placed by the client to engage new customers. A validity period is assigned to the client, based on the subscription that the client has with the system 63. Although customer details are aggregated even when the client's subscription has expired, the client is not allowed access to customer lists past the date of subscription and is thereby forced to renew their subscription for continued access to the system's features. The system constantly checks for any abuse of it by the client 64. If it detects any abuse by means of any illegal activities, it immediately deactivates or suspends the client's privileges 65. If no such abuse is suspected, the client is allowed regular, authenticated access to their space and customer lists 66. Further, the system backs up client data and performs maintenance all round 67.

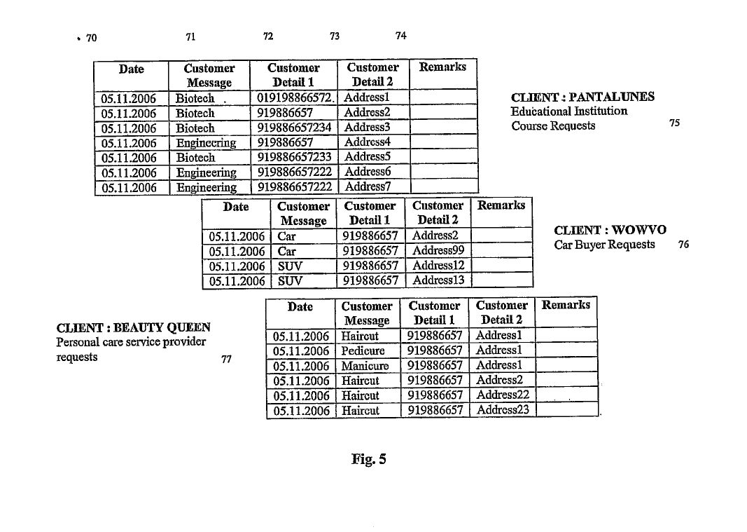

FIG. 5 depicts an overview of the customer details available to the client. Customer requests are aggregated in the data-store and typically contain the data with respect to the date 70 of receipt of the request, the customer message 71 which typically contains the keyword assigned to a particular client, customer details 72 and 73 and remarks. Clients have lists that are unique to them, indexed by the number of keywords, which they are assigned. For example, client 75 who is an educational institution, Pantalunes, is assigned the keywords biotech and engineering based on the courses they wish to advertise for. The list created for the client 75 holds the customer information, indexed by the product the customer is curious about. The client 76 is a car manufacturer, Wowvo, who is assigned the keywords car and SUV for two categories of vehicles. The client 77 is a personal care service provider who is assigned three keywords haircut, manicure and pedicure for three different services. Users of the system can repeat for the same product or client, across different clients and across different keywords, for one client. There is a lot of versatility provided to both the client and the customer. Further, the client can sort the lists based on any of the entry headers (date, keyword/customer message, customer details), view parts of the list, for example all entries pertaining to a certain time-period, all entries pertaining to a certain keyword, all entries pertaining to a certain regular customer etc. Using the section for remarks 74 the client is allowed to make entries for customers based on the action taken with respect to that particular customer. For example, if a demo has been scheduled with that customer, the client can make note of it in the remarks column. Further, these lists can be saved, manipulated and formatted in a variety of formats based on the client's requirements.

In one embodiment of this invention, the customers 3 (as shown in FIG. 1) can send their requests 33 by utilizing the Short Message Service (SMS), which is enabled in most mobile technologies world-wide. Typically, the request 33 would be sent to a pre-specified number (4, 6 or 10-digits long), which ultimately leads to the system of the present invention. Further, the request 33 could contain the e-mail address of the customer for rapid digital/electronic delivery of the sales brochures. Since the SMS is sent from a mobile platform, the customer's mobile phone number is immediately transmitted as part of the message. In this embodiment, in the process of interacting with the customer (as shown in FIG. 3), the request sent to the system 51 is typically an SMS, to the number placed in the ad (which leads to the system), with the keyword (supplied to the client by the system and placed by the client in the ad for his product/service) along with the email address of the client. The system authenticates the keyword and e-mail address 53 and updates the customers information 54 in its data-store. If the e-mail address or the keyword is invalid, an error message is communicated back to the customer. This error message could redirect the customer to the system's website or ask for a valid email address from the customer. Concurrency is built into the system for simultaneous access by several customers.

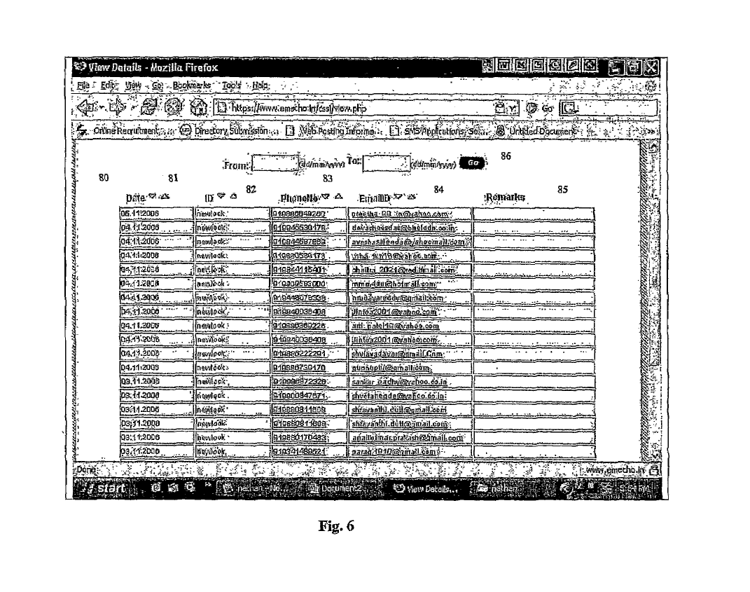

FIG. 6 shows the customer details made available to the client in this embodiment of the invention. The client 80 has a list for the keyword newlook and the details about the customer with regard to the date of his request 81, the keyword 82 which he is requesting the information for, the customer details such as his mobile phone number 83 and email address 84. Further, the client can still upload remarks 85 based on their interaction with the customers, sort the list based on a certain set of dates 86 etc.

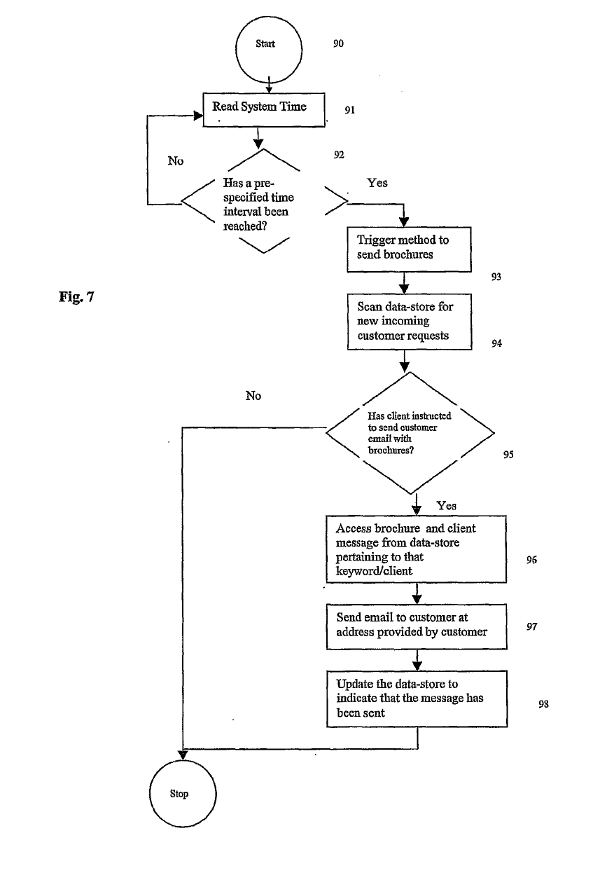

FIG. 7 shows the method used by the system to process customer requests, in this embodiment of the invention. The method starts 90 by reading the system time 91, after which it checks to see if a pre-specified time interval has been reached 92. If not, the system goes back to reading the system time 91. If the interval has been reached, the system triggers the method to send brochures 93. There is a scanning of the data-store 94 for new incoming customer requests which have been received and stored. If the client has instructed that the customer request be answered with an e-mail containing the brochure and other material 95 the brochure is accessed along with the client message, pertaining to the keyword which the customer has sent in 96. This email is sent to the customer at the address provided by the customer 97. The data-store is further updated to indicate that the message has been sent 98. The process terminates 99 after this step.

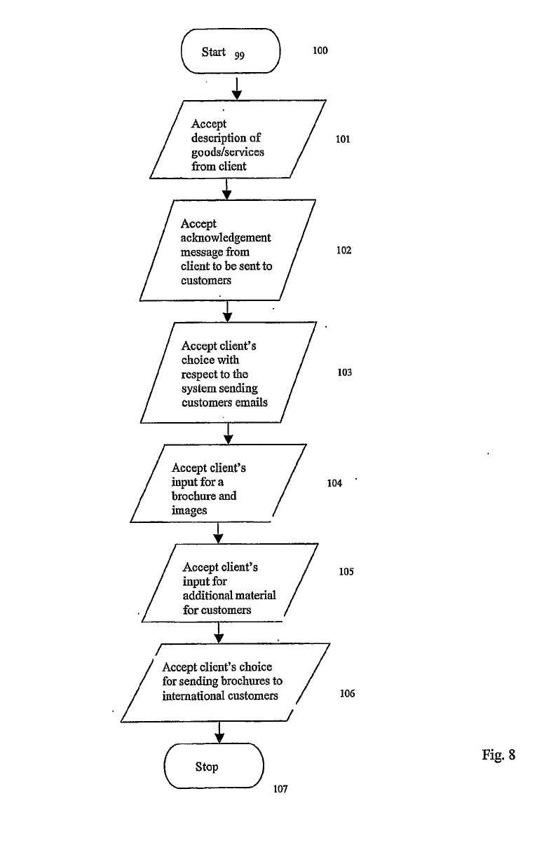

FIG. 8 shows the method to populate the data-store of the present invention by the clients. The process starts 100 by accepting a description of goods/services/material from the client 101. This is followed by accepting an acknowledgement message from the client, which is sent to the customers 102, at the time requests are received from the customers. Further, the system accepts the client's choice with respect to the system sending customers emails 103. Client input for brochures and associated images is taken 104 followed by the client's input for additional material to be sent to the customers 105. The client's choice for sending brochures to international customers 106 is also accepted, which leads to the end of the process 107.

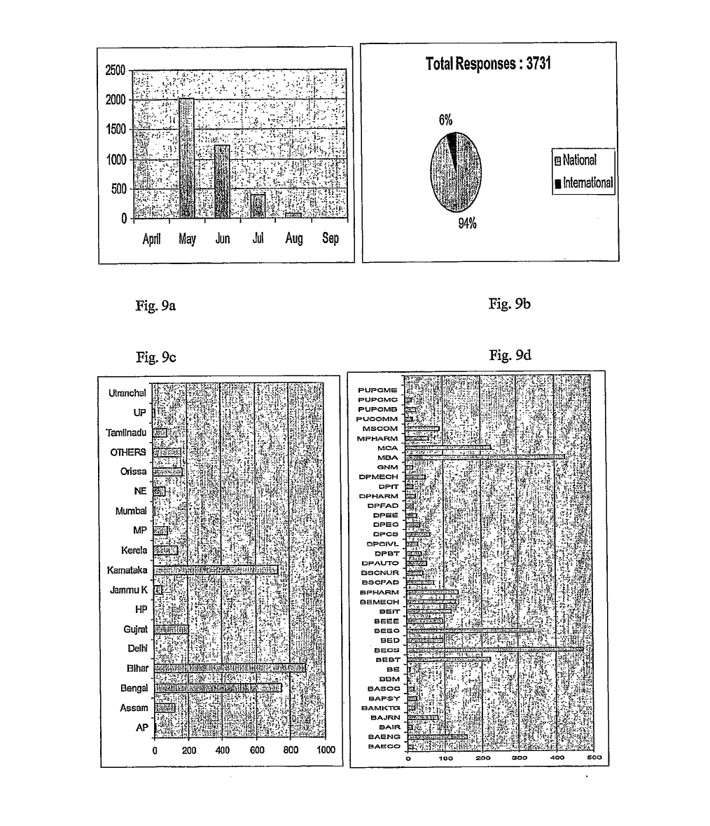

FIG. 9 shows the information that can be made available to the client based on data collected about customers. The analysis proceeds on the requests received from the system, pertaining to the customers who are associated with particular clients. One of the possible clients for this software could potentially be an educational institution, which offers brochures about its courses, to potential students. The kinds of information that the client might be interested include the monthly aggregation of the numbers of requests, as shown in FIG. 9a. The total responses, both internationally and nationally as shown in FIG. 9b. Further, the client may be interested in the geographical origin of the requests, as shown in FIG. 9c, which details the number of requests from different states within India. The number of requests based on keywords or in this particular case, the courses offered by the institution can also be collected and displayed to the client, as shown in FIG. 9d. The data is analyzed by accessing the data-store of the system, which logs the customer's details (as shown in 54 of FIG. 3) and mining for the required information.

1. A Real-Time system to disseminate information with material, including brochures, promotional material, marketing material and other supplemental material, involving interaction with one or more clients utilizing the system to aggregate and disseminate the material and analyze customer demographics and one or more customers who make requests to the system for the material, comprising:
a. Computer processor means for processing data;
b. Storage means for storing data on a storage medium;
c. First means for populating the storage medium;
d. Second means for accessing the storage medium;
e. Third means for updating the storage medium;
f. Fourth means for processing client interactions;
g. Fifth means for processing customer interactions; and
h. Sixth means for analyzing data pertaining to customers to provide information to clients.

2. A Real-Time system as claimed in claim 1, wherein the computer processor means further comprises:
a. Means for inputting and storing on a storage medium, information made available by the client;
b. Means for aggregating customer details based on requests sent to the system;
c. Means for creating locations on the storage medium for storing data regarding:
i. Customer requests comprising the request details, customer details and client remarks;
ii. Client material including brochures, promotional material, marketing material and other supplemental material;
iii. Archives of assimilated material; and
iv. Activity tracking information including lists.

3. A Real-Time system as claimed in claim 1, wherein the storage means further comprises:
a. Means for retrieving from the storage medium data pertaining to customers and clients; and
b. Means for inputting and storing on the storage medium data pertaining to maintenance functions performed in the system.

4. A Real-Time system as claimed in claim 1, wherein the first means further comprises:
a. Means to accept descriptions, including that of goods/services/promotional/marketing material from the client;
b. Means to accept acknowledgment messages which the clients wish to send to their potential customers who are making requests for client material;
c. Means to accept the client's choice with respect to whether or not the system is to send e-mail to the customers, containing the client's material;
d. Means to accept the client's input for their material, including brochures, promotional material, marketing material and other supplemental material; and
e. Means to accept the client's choice for sending material to international customers.

5. A Real-Time system as claimed in claim 1, wherein the second means further comprises:
a. Authentication means for verifying the identity of the entity trying to access the storage medium;
b. Means for making redundant copies of the current storage medium for purposes of failure resolution;
c. Means for alerting the system when an abuse is detected; and
d. Means for suspending or de-activating accesses to the storage medium upon detection of abuse.

6. A Real-Time system as claimed in claim 1, wherein the third means further comprises:
a. Updating the storage medium to identify customers who have been sent material;
b. Updating the storage medium to include the client's remarks regarding interactions with the customers;
c. Updating the storage medium to indicate the validity of a client's subscription; and
d. Updating the storage medium to contain material including brochures, promotional material, marketing material and other supplemental material made available by the client.

7. A Real-Time system as claimed in claim 1, wherein the fourth means further comprises:
a. Means to activate the client by establishing authenticating identifiers, keywords for use by the client and setting terms of validity of the client's subscription with the system;
b. Means to populate the storage medium based on inputs from the client, which the clients wish to make available to the customer;
c. Means to allow the client to edit the material which they have stored in the storage medium;
d. Means to authenticate the client in order to allow the client access to their space within the system comprising their uploaded material and their customer information; and
e. Means to raise an alert when an unauthenticated client has been trying to access the system.

8. A Real-Time system as claimed in claim 1, wherein the fifth means further comprises:
a. Receiving a request for a client's material, from a customer;
b. Authenticating the delivery address and message provided by the customer;
c. Upon authentication of both the delivery address and the message provided by the customer:
i. Updating the system's storage medium with the customer's details;
ii. Looking up pertinent client material in the storage medium; and
iii. Delivering the material found in step ii, to the recorded customer address.
d. Upon failure to authenticate either of the message or the delivery address:
i. Sending the customer an appropriate error message; and
ii. Updating the system's storage medium with the customer's details.

9. A Real-Time system as claimed in claim 1, wherein the sixth means further comprises:
a. The ability to analyze geographical information pertaining to incoming requests based on the telephone number of the customer;
b. The ability to analyze the frequency of requests based on the keywords used by the customer; and
c. The ability to analyze the timing of the requests with information based on certain dated periods over the years, based on incoming requests.

10. A Real-Time system as claimed in claim 8, wherein the request received from the customer could be in the form of a short message service, enabled world-wide on mobile platforms.

11. A Real-Time system as claimed in claim 8, wherein the request received from the customer could be in the form of a short message service, enabled world-wide on mobile platforms wherein:
a. The requests are sent to a pre-specified number, which redirects automatically to the system of the present invention, said number being placed in the advertisements by the clients;
b. The number that the requests are sent to being any of 4, 6 or 10 digits in length;
c. The number that the requests are sent to being anywhere in the world;
d. The requests containing an implicit identifier of the customer, being their mobile phone number, and a set of explicit identifiers sent by the customer including:
i. The keyword which was placed in the advertisement by the client, which identifies the product or service for which the customer seeks brochures, promotional material, marketing material or other supplemental material; and
ii. The e-mail address of the customer, which the customer provides in order to receive the information from the system.

12. A Real-Time system as claimed in claim 6, wherein updating the system's storage medium with the customer's details comprises such details as:
a. The customers mobile phone number;
b. The date on which the request was sent;
c. The customers keyword, which identifies the product or service for which they seek client material;
d. The customer's email address; and
e. Remarks updated by the client with respect to their interactions with the customer.

13. A Real-Time system as claimed in claim 8, wherein lists containing the customer's information are aggregated for the respective clients to view, sort, manipulate and store in a variety of formats.

14. A Real-Time system as claimed in claim 7, wherein the fourth means further comprises:
a. Means to read the system time to check if a pre-specified interval has been reached;
b. Upon reaching the pre-specified interval:
i. Sending client material to the customer including:
1. Scanning the storage medium of the system for new requests from the customer for material including brochures, promotional material, marketing material and other supplemental material;
2. Checking to see if the client has asked the system to respond with an e-mail to the customer, sent to the address specified by the customer;
3. Accessing the storage medium to retrieve the pertinent material, placed therein by the client;
4. If the client has asked for an e-mail to be sent, sending that e-mail containing the material placed by the client wherein:
a. Additionally a message from the client could also be sent;
5. Updating the storage medium to indicate that a message has been sent containing the material to the customer requesting the material.

15. A system of claim 1 which is accessible by one or more clients and one or more customers wherein:
a. The clients and the customers are geographically concurrent or separated;
b. The requests from the customers are temporally concurrent or separated;
c. There are one or more requests from one or more clients for one or more products or services which can be serviced in real-time;
d. The clients and customers are located across national and communication borders; and
e. The components of the system are spatially distributed;

16. A method to disseminate information with material including brochures, promotional material, marketing material and other supplemental material, while enhancing the effect of advertisements placed in digital and print media, comprising the steps of:
a. Populating a storage medium with information about clients and customers;
b. Accessing the storage medium;
c. Updating the storage medium;
d. Processing client interactions;
e. Processing customer interactions; and
f. Analyzing data pertaining to customers to provide information to clients.

17. A method as claimed in claim 16, wherein populating the storage medium further comprises:
a. Accepting one or more descriptions including that of goods/services/promotional/marketing information from the client;
b. Accepting acknowledgment messages which the clients wish to send to their potential customers who are making requests for material including brochures, promotional material, marketing material and other supplemental material;
c. Accepting the client's choice with respect to whether or not the system is to send e-mail to the customers, containing the client's material; and
d. Accepting the client's choice for sending material to international customers.

18. A method as claimed in claim 16, wherein accessing the storage medium further comprises:
a. Authenticating the identity of the entity trying to access the storage medium;
b. Making redundant copies of the current storage medium for purposes of failure resolution;
c. Alerting the system when an abuse is detected; and
d. Suspending or de-activating accesses to the storage medium upon detection of abuse.

19. A method as claimed in claim 16, wherein updating the storage medium further comprises:
a. Updating the storage medium to identify customers who have been sent material;
b. Updating the storage medium to include the client's remarks regarding interaction with the customers;
c. Updating the storage medium to indicate the validity of a client's subscription; and
d. Updating the storage medium to contain material including brochures, promotional material, marketing material and other supplemental material made available by the client.

20. A method as claimed in claim 16, wherein processing client interactions further comprises:
a. Activating the client by establishing authenticating identifiers, keywords for use by the client and setting terms of validity of the client's subscription with the system;
b. Populating the storage medium based on inputs from the client with material which the client wishes to make available to the customer;
c. Allowing the client to edit the material which they have stored in the storage medium;
d. Authenticating the client in order to allow the client access to their space within the system comprising their uploaded material and their customer information; and
e. Raising an alert when an unauthenticated client has been trying to access the system.

21. A method as claimed in claim 16, wherein processing customer interactions further comprises:
a. Receiving a request for client material, including brochures, promotional material, marketing material and other supplemental material, from a customer;
b. Authenticating the delivery address and message provided by the customer;
c. Upon authentication of both the delivery address and the message provided by the customer:
i. Updating the system's storage medium with the customer's details;
ii. Looking up pertinent information in the storage medium; and
iii. Delivering brochures to the recorded customer address.
d. Upon failure to authenticate either of the message or the delivery address:
i. Sending the customer an appropriate error message; and
ii. Updating the system's storage medium with the customer's details.

22. A method as claimed in claim 16, wherein analyzing data pertaining to customers further comprises:
a. Analyzing geographical information pertaining to incoming requests based on the telephone number of the customer;
b. Analyzing the frequency of requests based on the keywords used by the customer; and
c. Analyzing the timing of the requests with information based on certain dated periods over the years, based on incoming requests.

23. A method as claimed in claim 21, wherein the request received from the customer could be in the form of a short message service, enabled world-wide on mobile platforms.

24. A method as claimed in claim 21, wherein the request received from the customer could be in the form of a short message service, enabled world-wide on mobile platforms wherein:
a. The requests are sent to a pre-specified number, which redirects automatically to the system of the present invention, said number being placed in the advertisements by the clients;
b. The number that the requests are sent to being any of 4, 6 or 10 digits in length;
c. The number that the requests are sent to being anywhere in the world;
d. The requests containing an implicit identifier of the customer, being their mobile phone number, and a set of explicit identifiers sent by the customer including:
i. The keyword which was placed in the advertisement by the client, which identifies the product or service for which the customer seeks brochures, promotional material, marketing material or other supplemental material for; and
ii. The e-mail address of the customer, which the customer provides in order to receive the information from the system.

25. A method as claimed in claim 19, wherein updating the system's storage medium with the customer's details comprises such details as:
a. The customers mobile phone number;
b. The date on which the request was sent;
c. The customers keyword, which identifies the product or service for which they seek material;
d. The customer's email address; and
e. Remarks updated by the client with respect to their interactions with the customer.

26. A method as claimed in claim 21, wherein lists containing the customer's information are aggregated for the respective clients to view, sort, manipulate and store in a variety of formats.

27. A method as claimed in claim 20, wherein processing customer interactions further comprises:
a. Reading the system time to check if a pre-specified interval has been reached;
b. Upon reaching the pre-specified interval:
i. Triggering the sending of brochures comprising the steps of:
1. Scanning the storage medium of the system for new requests from the customer for material including brochures, promotional material, marketing material and other supplemental material;
2. Checking to see if the client has asked the system to respond with an e-mail to the customer, sent to the address specified by the customer;
3. Accessing the storage medium to retrieve the pertinent material, placed therein by the client;
4. If the client has asked for an e-mail to be sent, sending that e-mail containing the material including brochures, promotional material, marketing material and other supplemental material, placed by the client wherein:
a. Additionally a message from the client could also be sent;
5. Updating the storage medium to indicate that a message has been sent containing the material to the customer requesting the material.

28. A method of claim 16 where one or more clients and one or more customers can be present wherein:
a. The clients and the customers are geographically concurrent or separated;
b. The requests from the customers are temporally concurrent or separated;
c. There are one or more requests from one or more clients for one or more products or services which can be serviced in real-time;
d. The clients and customers are located across national and communication borders; and
e. The components of the system are spatially distributed;
